(19) United States
(12) Patent Application Publication
(10) Pub. No.: US 2007/0103458 A1
(43) Pub. Date: May 10, 2007

(54) DRIVING IC AND DISPLAY DEVICE

(75) Inventor: Shougo Kawahigashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/556,873

(22) Filed: Nov. 6, 2006

(30) Foreign Application Priority Data
Nov. 7, 2005 (JP) 2005-322596

(51) Int. Cl. G09G 5/00

(52) U.S. Cl. 345/204

(57) ABSTRACT

According to an embodiment of the present invention, a driving IC incorporated in a display device, includes: a first field effect transistor among field effect transistors at an output stage, which is supplied with an output control signal not through the other field effect transistors; a plurality of divided gate electrodes provided in the first field effect transistor; and a delay unit shifting ON/OFF timings of at least a part of the plurality of gate electrodes.

### BACKGROUND OF THE INVENTION

1. Field of the Invention

The present invention relates to a driving IC incorporated in a display device, and a display device incorporating the driving IC.

2. Description of Related Art

As a configuration example of an output circuit of a driving IC (integrated Circuit) (for example, Japanese Unexamined Patent Publication No. 11-231829) in a display device, there have been known a CMOS (Complementary Metal Oxide Semiconductor) type circuit composed of a P-type field effect transistor (FET) and an N-type field effect transistor, and a totem-pole type one composed of two N-type field effect transistors.

FIG. 8 is a circuit diagram of a main part of a CMOS type driving IC of the Related Art 1. FIG. 9 is a circuit diagram of a main part of an N-type totem-pole type driving IC of the Related Art 2.

A CMOS type driving IC 100 of FIG. 8 includes terminals for three output circuit control signals (a first output circuit control signal S1, a second output circuit control signal S2, and a third output circuit control signal S3), and field effect transistors of a first conductivity type and field effect transistors of a second conductivity type which are sequentially series-connected with the terminals. To be specific, the terminal of the first output circuit control signal S1 is connected with a gate of a first N-channel (hereinafter simply referred to as “N-type (first conductivity type)”) driver transistor N1. The terminal of the second output circuit control signal S2 is connected with a gate of a second N-type driver transistor N2. The terminal of the third output circuit control signal S3 is connected with an N-type output transistor Nₒᵤₜ1.

Further, the first N-type driver transistor N1 has a drain terminal connected with a drain terminal of a first P-channel (hereinafter simply referred to as “P-type (second conductivity type)”) driver transistor P1 The second N-type driver transistor N2 has a drain terminal connected with a drain terminal of a second P-type driver transistor P2. In addition, the N-type output transistor Nₒᵤₜ1 has a drain terminal connected with a drain terminal of a P-type output transistor Pₒᵤₜ1. The circuit is configured such that an output (OUT) is taken from an output node as the connection point therebetween.

Source terminals of the P-type output transistor Pₒᵤₜ1, the second P-type driver transistor P2, and the first P-type driver transistor P1 are connected with one power supply unit Vcc. A connection point between drain terminals of the first P-type driver transistor P1 and the first N-type driver transistor N1 is connected with a gate of the second P-type driver transistor P2. A connection point between drain terminals of the second P-type driver transistor P2 and the second N-type driver transistor N2 is connected with a gate of the first P-type driver transistor P1 and with a gate of the P-type output transistor Pₒᵤₜ1.

Source terminals of the N-type output transistor Nₒᵤₜ1, the second N-type driver transistor N2, and the first N-type driver transistor N1 are each grounded. A portion surrounded by the dashed line of FIG. 8, that is, the power supply unit Vcc, the P-type output transistor Pₒᵤₜ1, and the N-type output transistor Nₒᵤₜ1 function as a CMOS type output stage 101.

A totem-pole type driving IC 200 of FIG. 9 includes, similar to the aforementioned CMOS type driving IC 100, terminals for the three output circuit control signals (the first output circuit control signal S1, the second output circuit control signal S2, and the third output circuit control signal S3), and its configuration is the same as the CMOS type driving IC 100 except that an N-type FET totem-pole type output stage 102 is used in place of the CMOS type output stage 101 in the above example. More specifically, the N-type FET totem-pole type output stage 102 includes two N-type output transistors (a first N-type output transistor Nₒᵤₜ1 and a second N-type output transistor Nₒᵤₜ2), a Zener diode D1, and a power supply unit Vcc.

Now, description is given of a point of difference between the configuration of the N-type FET totem-pole type output stage 102 and that of the CMOS type output stage 101. The terminal of the third output circuit control signal S3 is connected with a gate of the first N-type output transistor Nₒᵤₜ1. A drain terminal of the first N-type output transistor Nₒᵤₜ1 is connected with a drain terminal of the second N-type output transistor Nₒᵤₜ2. An output (OUT) is taken from an output node as a connection point therebetween as in the CMOS type driving IC. On the other hand, the Zener diode D1 is provided between the above connection point and a connection point between the drain terminals of the second P-type driver transistor P2 and the second N-type driver transistor N2. A cathode of the Zener diode D1 is connected with a gate of the second N-type output transistor Nₒᵤₜ2. A source terminal of the second N-type output transistor Nₒᵤₜ2 is connected with the power supply unit Vcc, and a source terminal of the first N-type output transistor Nₒᵤₜ1 is grounded.

Incidentally, the power supply unit Vcc is connected with the first P-type driver transistor P1 and the second P-type driver transistor P2 as in the CMOS type driving IC. Further, the arrangement of the first P-type driver transistor P1, the second P-type driver transistor P2, the first N-type driver transistor N1, the second N-type driver transistor N2, the terminal of the first output circuit control signal S1, and the terminal of the second output circuit control signal S2 is the same as the CMOS type driving IC 100 except for the above-described points.

However, the Related Arts 1 and 2 involve a problem in that, if a field effect transistor of high current output power is used, a noise level is increased.

FIG. 10 is a schematic plan view illustrating how a signal line is connected with a gate electrode of the N-type output transistor Nₒᵤₜ1 of the Related Arts 1 and 2. The N-type output transistor Nₒᵤₜ1 serves as a field effect transistor (hereinafter referred to as “first field effect transistor”) supplied with an output control signal not through the other field effect transistors, among the field effect transistors at the output stage of the Related Arts 1 and 2. In FIG. 10, reference numeral 103 denotes an isolation trench; 104, a source diffusion layer; 105, a drain diffusion layer; 106, a gate electrode; 107, a signal line; 108a, a first cell; 108b, a second cell; and 108c, a third cell.

The N-type output transistor Nₒᵤₜ1 may be divided into cells. In this example, it is assumed that the transistor Nₒᵤₜ1 is divided into three cells. As shown in FIG. 10, the signal line 107 is connected with the gate electrode 106 in the three cells (108a, 108b, and 108c) as a common line. Thus, the three cells (108a, 108b, and 108c) in the N-type output transistor Nₒᵤₜ1 are turned ON/OFF instantaneously at substantially the same time. As a result, the first field effect transistor (N-type output transistor Nₒᵤₜ1) operates with the maximum current output power just from the falling edge (or rising edge) of the output waveform.

In the case where the first field effect transistor operates with the maximum current output power just from the falling edge (or rising edge) of the output waveform, a switching waveform inevitably becomes steep, which causes a noise. A method of suppressing a current output power of the field effect transistor has been reported as a method of suppressing the noise. In many cases, however, driving ICs for display device especially require field effect transistors of high current output power. To that end, there is an increasing demand for a technique of reducing a noise level regardless of the current output power of the field effect transistor.

### SUMMARY OF THE INVENTION

According to an aspect of the present invention, a driving IC incorporated in a display device, includes: a first field effect transistor among field effect transistors at an output stage, which is supplied with an output control signal not through the other field effect transistors; a plurality of divided gate electrodes provided in the first field effect transistor; and a delay unit shifting ON/OFF timings of at least a part of the plurality of gate electrodes.

According to the driving IC of the present invention, a gate electrode of a first field effect transistor is divided into a plurality of electrodes to shift ON/OFF timings of at least a part of the electrodes, making it possible to suppress an excessive current output power just on the falling edge (or rising edge) without controlling a current output power of the field effect transistor unlike the related arts. Hence, it is possible to reduce an increase in noise level due to an abrupt switching operation regardless of the current output power of the field effect transistor.

As beneficial effects of the present invention, it is possible to provide a driving IC capable of reducing a noise level regardless of a current output power of a field effect transistor, and a display device incorporating the driving IC.

### BRIEF DESCRIPTION OF THE DRAWINGS

The above and other objects, advantages and features of the present invention will be more apparent from the following description taken in conjunction with the accompanying drawings, in which:

FIG. 1 is a circuit diagram of a main part of a CMOS type driving IC according to a first embodiment of the present invention;

FIG. 2 is a schematic plan view illustrating how a signal line is connected with a gate electrode of an output transistor of the first embodiment;

FIG. 3 shows a falling waveform of an output voltage of a driving IC for display device of the first embodiment;

FIG. 4 shows a dependence of an output waveform on a load at the falling edge in the driving IC of the first embodiment;

FIG. 5 is a circuit diagram of a main part of an N-type totem-pole type driving IC according to a second embodiment of the present invention;

FIG. 6 is a schematic plan view illustrating how a signal line is connected with a gate electrode of an output transistor of the third embodiment;

FIG. 7 shows how an output waveform falls in a driving IC according to a third embodiment of the present invention;

FIG. 8 is a circuit diagram of a main part of a CMOS type driving IC of the Related Art 1;

FIG. 9 is a circuit diagram of a main part of an N-type totem-pole type driving part IC of the Related Art 2;

FIG. 10 is a schematic plan view illustrating how a signal line is connected with a gate electrode of the output transistor of the Related Arts 1 and 2; and

FIG. 11 shows a falling waveform of an output voltage of a driving IC for display device of the Related Arts 1 and 2.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

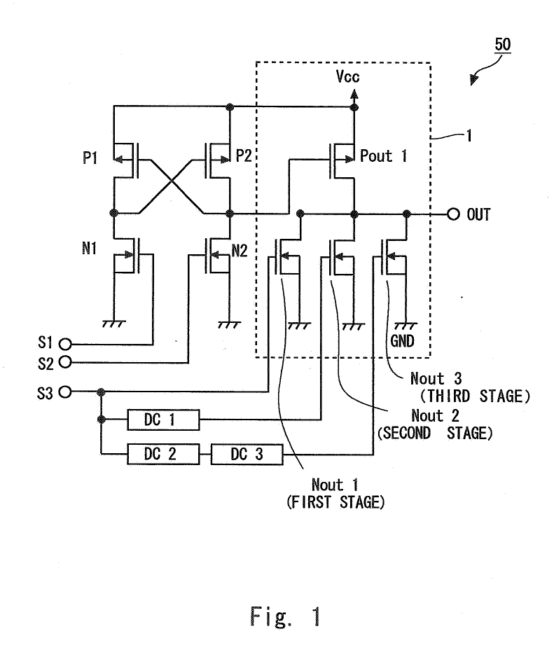

FIG. 1 is a circuit diagram of a main part of a CMOS type driving IC according to a first embodiment of the present invention. A CMOS type driving IC 50 of FIG. 1 includes terminals for three output circuit control signals (a first output circuit control signal S1, a second output circuit control signal S2, and a third output circuit control signal S3), and a field effect transistor of a first conductivity type and a field effect transistor of a second conductivity type which are sequentially series-connected with the terminals. To be specific, the terminal of the first output circuit control signal S1 is connected with a gate of a first N-type (first conductivity type) driver transistor N1. The terminal of the second output circuit control signal S2 is connected with a gate of a second N-type driver transistor N2.

The terminal of the third output circuit control signal S3 is parallel-connected with a first N-type output transistor Nₒᵤₜ1 a second N-type output transistor Nₒᵤₜ2, and a third N-type output transistor Nₒᵤₜ3 as field effect transistors of a first conductivity type through signal lines. A first delay circuit DC 1 is provided between the terminal of the third output circuit control signal S3 and the second N-type output transistor Nₒᵤₜ2. A second delay circuit DC 2 and a third delay circuit DC 3 are connected in this order between the terminal of the third output circuit control signal S3 and the third N-type output transistor Nₒᵤₜ3.

Drain terminals of the first N-type output transistor Nₒᵤₜ1, the second N-type output transistor Nₒᵤₜ2, and the third N-type output transistor Nₒᵤₜ3 are connected with a P-type (second conductivity type) output transistor Pₒᵤₜ1 as a field effect transistor of a second conductivity type. An output node as a connection point therebetween is connected with an output terminal (OUT).

Source terminals of the P-type output transistor Pₒᵤₜ1, the second P-type driver transistor P2, and the first P-type driver transistor P1 are connected with one power supply unit Vcc. The first N-type driver transistor N1 has a drain terminal connected with a drain terminal of the first P-type driver transistor P1. Further, the second N-type driver transistor N2 has a drain terminal connected with a drain terminal of the second P-type driver transistor P2. In addition, a connection point between the drain terminals of the first P-type driver transistor P1 and the first N-type driver transistor N1 is connected with a gate of the second P-type driver transistor P2. A connection point between the drain terminals of the second P-type driver transistor P2 and the second N-type driver transistor N2 is connected with a gate of the first P-type driver transistor P1 and with a gate of the P-type output transistor Pₒᵤₜ1.

Source terminals of the first N-type output transistor Nₒᵤₜ1, the second N-type output transistor Nₒᵤₜ2, the third N-type output transistor Nₒᵤₜ3 the second N-type driver transistor N2, and the first N-type driver transistor N1 are each grounded. A portion surrounded by the dashed line of FIG. 1, that is, the power supply unit Vcc, the P-type output transistor Pₒᵤₜ1, the first N-type output transistor Nₒᵤₜ1, the second N-type output transistor Nₒᵤₜ2, and the third N-type output transistor Nₒᵤₜ3 function as a CMOS type output stage 1. Incidentally, the first N-type output transistor Nₒᵤₜ1, the second N-type output transistor Nₒᵤₜ2, and the third N-type output transistor Nₒᵤₜ3 are collectively referred also as “first field effect transistors” herein.

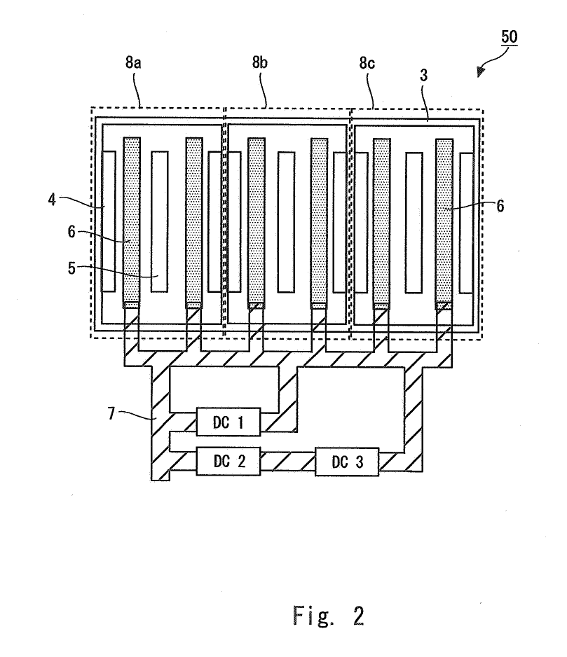

FIG. 2 is a schematic plan view illustrating how a signal line is connected with a gate electrode of the first field effect transistor (the first N-type output transistor Nₒᵤₜ1, the second N-type output transistor Nₒᵤₜ2, and the third N-type output transistor Nₒᵤₜ3). In FIG. 2, reference numeral 3 denotes an isolation trench; 4, a source diffusion layer; 5, a drain diffusion layer; 6, a gate electrode; and 7, a signal line. In addition, reference symbol 8a denotes a first cell including the gate electrode of the first N-type output transistor Nₒᵤₜ1; 8b, a second cell including the gate electrode of the second N-type output transistor Nₒᵤₜ2; and 8c, a third cell including the gate electrode of the third N-type output transistor Nₒᵤₜ3.

The signal line 7 is branched such that gates of the first cell 8a, the second cell 8b, and the third cell 8c are turned ON/OFF at different timings. A first delay circuit DC 1 is provided on the signal line 7 for supplying signals to the second cell 8b. A second delay circuit DC 2 and a third delay circuit DC 3 are provided on the signal line 7 for supplying signals to the third cell 8c. In this example, the first delay circuit DC 1, the second delay circuit DC 2, and the third delay circuit DC 3 have the same circuit configuration. Hence, circuit components can be shared. Each cell includes two gate electrodes 6. Further, the signal line 7 is finally branched and connected with the two gate electrodes 6 in each cell. Thus, the gate electrodes 6 of each cell are concurrently turned ON/OFF.

The provision of the first delay circuit DC 1, the second delay circuit DC 2, and the third delay circuit DC 3 makes it possible to shift ON/OFF timings of the gates of the first N-type output transistor Nₒᵤₜ1, the second N-type output transistor Nₒᵤₜ2, and the third N-type output transistor Nₒᵤₜ3 on the falling (or rising) edge of an output voltage in a stepwise fashion. As a result, it is possible to avoid such a situation that the first field effect transistors are switched with the maximum current output power.

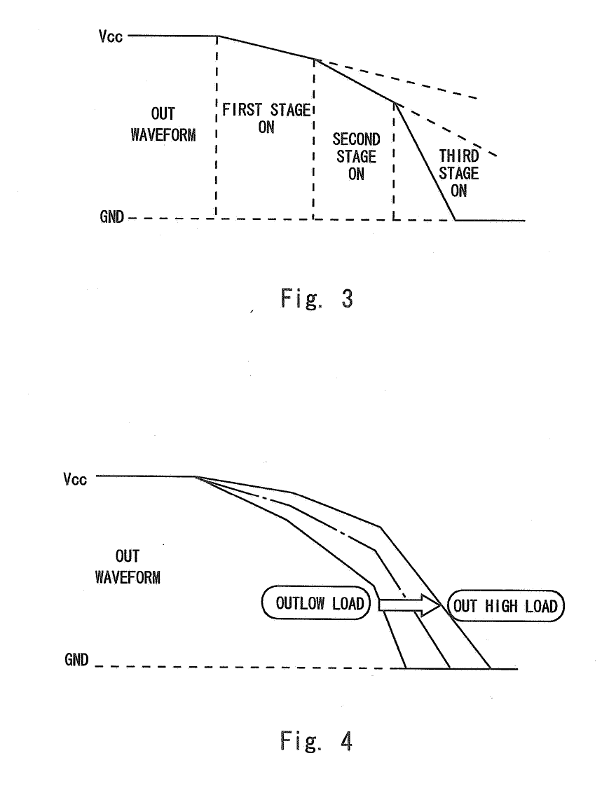

FIG. 3 shows a falling waveform of an output voltage of a driving IC for display device of the first embodiment. The configuration of the driving IC of the first embodiment enables multistage variable voltage control as shown in FIG. 3. Hence, it is possible to suppress an excessive current output power just on the falling edge (or rising edge), and to reduce an increase in noise level due to an abrupt switching operation.

The Related Art 1 involves a problem in that a high dependence of output load variations on a driving method of a display device as well as a problem in that a noise level increases if the aforementioned transistor of high current output power is used. This is because the circuit operates with the maximum current output power all the time. FIG. 11 shows a dependence of an output waveform on a load on the falling edge thereof in a driving IC 100 of the Related Art 1. As shown in FIG. 11, the dependence of the output load variations on the driving method of a display device is substantially high. This problem cannot be overcome even if the current output power of the transistor is suppressed, unlike the problem about how to reduce a noise level. The same holds true for the Related Art 2.

FIG. 4 shows a dependence of an output waveform on a load at the falling edge in the driving IC 50 of the first embodiment. According to the driving IC 50 of the first embodiment, as shown in FIG. 4, the dependence of output load variations on the driving method of the display device can be reduced as compared with the Related Arts 1 and 2. This is because the ON/OFF timings of the gates of the first N-type output transistor Nₒᵤₜ1, the second N-type output transistor Nₒᵤₜ2, and the third N-type output transistor Nₒᵤₜ3 can be shifted in a stepwise fashion as described above, so an excessive current output power just on the falling edge (or rising edge) can be suppressed. Further, attained is an effect of suppressing so-called EMI (ELECTROMAGNETIC INTERFERENCE) that is the phenomenon that the electromagnetic wave generated from an electronic circuit during the operation of an electric device adversely affects the other peripheral devices.

Incidentally, the number of gate electrodes 6 of FIG. 2 and the number of signal lines 7 connected with the gate electrodes 6 are determined for ease of explanation, and can be, of course, arbitrarily set. Further, as for the delay circuits DCs (DC 1, DC 2, and DC 3), the same delay circuits DCs with the same delay time may be used or different delay circuits DCs may be used. Further, the second delay circuit DC 2 and the third delay circuit DC 3 may be integrated into one delay circuit DC such that the one delay circuit DC has a delay time different from that of the first delay circuit DC 1 to thereby realize the similar circuit configuration as the above circuit. Further, the circuit may be configured in such a manner that the delay time differs among the plural divided cells, or the same delay time for some of the plural cells is appropriately provided depending on required performance and characteristics of the display device. Further, a delay circuit DC may be provided on the finally branched signal line 7 for supplying signals to the gate electrodes in one cell, for example, to the two gate electrodes 6 in the first cell 8a to shift ON/OFF timings of the gate electrodes 6 in one cell.

### Second Embodiment

Next, a driving IC different from that of the first embodiment is described. Incidentally, in the following description, the same main components as those of the first embodiment are denoted by identical reference numerals, and description thereof is omitted if not necessary.

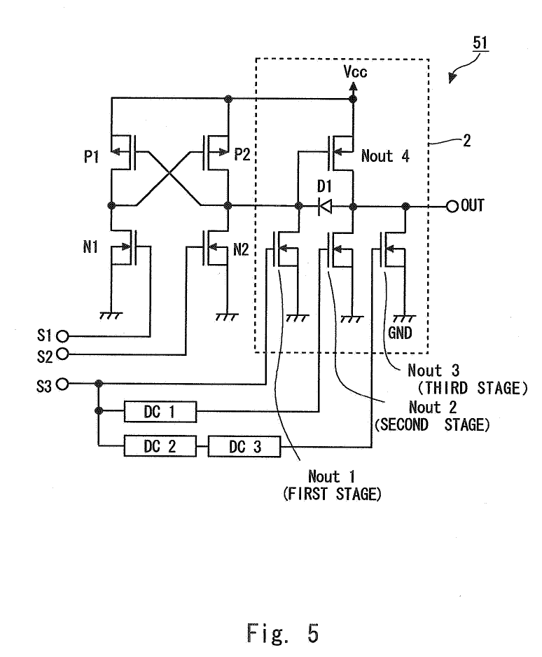

FIG. 5 is a circuit diagram of a main part of an N-type totem-pole type driving IC according to a second embodiment of the present invention. Similar to the above CMOS type driving IC 50, a totem-pole type driving IC 51 of the second embodiment includes the terminals of the three output circuit control signals (first output circuit control signal S1, the second output circuit control signal S2, and the third output circuit control signal S3), and has the same configuration as that of the CMOS type driving IC 100 except that an N-type FET totem-pole type output stage 2 is used in place of the CMOS type output stage 1 of the above example. To be specific, the N-type FET totem-pole type output stage 2 includes four N-type output transistors (a first N-type output transistor Nₒᵤₜ1, a second N-type output transistor Nₒᵤₜ2, a third N-type output transistor Nₒᵤₜ3, and a fourth N-type output transistor Nₒᵤₜ4), the Zener diode D1, and the power supply unit Vcc.

Hereinafter, description is made of a point of difference between the configuration of the output stage 2 and that of the CMOS type output stage 1. The terminal of the third output circuit control signal S3 is connected with gates of the first N-type output transistor Nₒᵤₜ1, the second N-type output transistor Nₒᵤₜ2, and the third N-type output transistor Nₒᵤₜ3. Drain terminals thereof are connected with a drain terminal of the fourth N-type output transistor Nₒᵤₜ4. An output node as a connection point therebetween is connected with an output terminal (OUT) as in the CMOS type driving IC.

Meanwhile, the Zener diode D1 is provided between a connection point between the drain terminal of the first N-type output transistor Nₒᵤₜ1 and the gate of the fourth N-type output transistor Nₒᵤₜ4, and a connection point between the drain terminal of the second N-type output transistor Nₒᵤₜ2 and the source terminal of the fourth N-type output transistor Nₒᵤₜ4. The second N-type output transistor Nₒᵤₜ2, third N-type output transistor Nₒᵤₜ3 is connected with an anode of the Zener diode D1. Thus, an output waveform can fall through the diode with efficiency. The source terminal of the fourth N-type output transistor Nₒᵤₜ4 is connected with the power supply unit Vcc. Source terminals of the first N-type output transistor Nₒᵤₜ1, the second N-type output transistor Nₒᵤₜ2, and the third N-type output transistor Nₒᵤₜ3 are grounded.

Incidentally, the power supply unit Vcc is connected with the first P-type driver transistor P1 and the second P-type driver transistor P2 as in the CMOS type driving IC. Further, the arrangement of the first P-type driver transistor P1, the second P-type driver transistor P2, the first N-type driver transistor N1, the second N-type driver transistor N2, the terminal of the first output circuit control signal S1, and the terminal of the second output circuit control signal S2 is the same as that of the CMOS type driving IC 50 except for the above-described points.

A portion surrounded by the dashed line of FIG. 5, that is, the power supply unit Vcc, the first N-type output transistor Nₒᵤₜ1, the second N-type output transistor Nₒᵤₜ2, the third N-type output transistor Nₒᵤₜ3, the fourth N-type output transistor Nₒᵤₜ4, and the Zener diode D1 function as the totem-pole type output stage 2. Incidentally, the first N-type output transistor Nₒᵤₜ1, the second N-type output transistor Nₒᵤₜ2, and the third N-type output transistor Nₒᵤₜ3 are collectively referred to also as “first field effect transistors” herein.

In the totem-pole type driving IC 51 of the second embodiment as well, a schematic plan view illustrating how a signal line is connected with gate electrodes of the first field effect transistors (the first N-type output transistor Nₒᵤₜ1, the second N-type output transistor Nₒᵤₜ2, and the third N-type output transistor Nₒᵤₜ3) is the same as the first embodiment as shown in FIG. 2. Further, a dependence of an output waveform on a load at the falling edge of an output voltage in the driving IC is also the same as that of the first embodiment (see FIGS. 3 and 4). As a result, it is possible to provide a driving IC capable of reducing a noise level regardless of the current output power of the transistor. Similar to the first embodiment, an effect of suppressing the EMI can be also attained. Further, a dependence of output load variations on the driving method of a display device can be reduced as compared with the conventional example.

### Third Embodiment

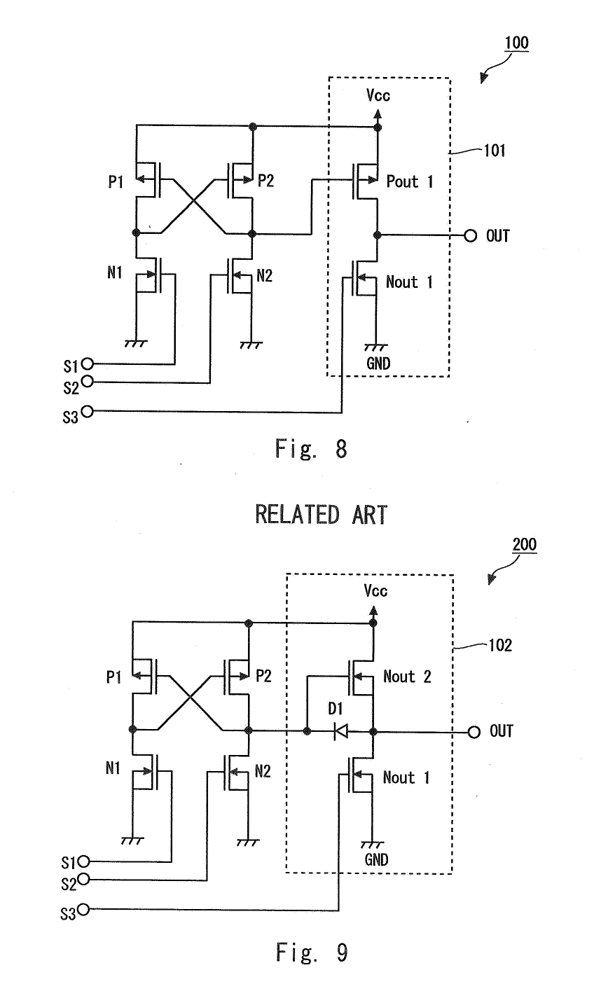

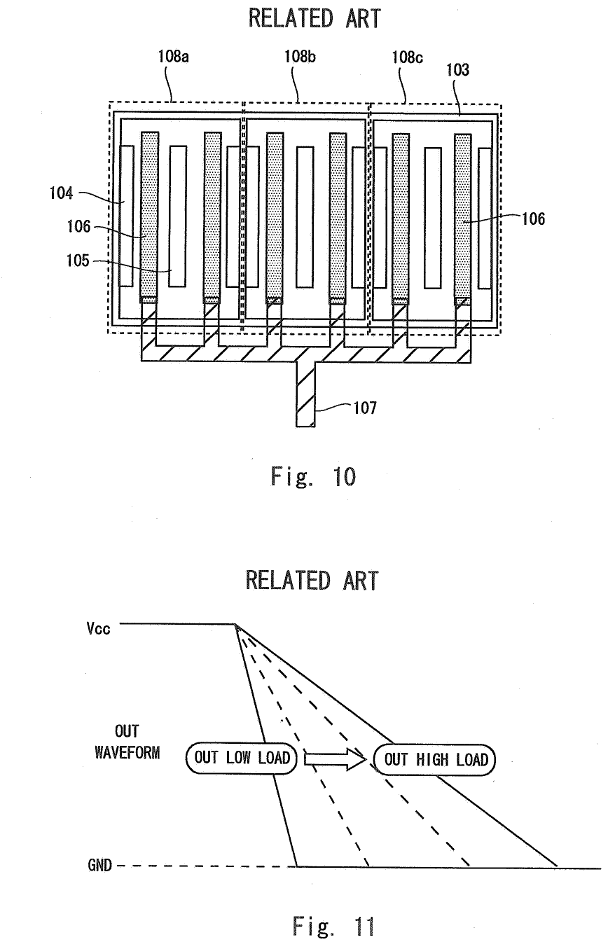

Next, a driving IC different from those of the first and second embodiments is described. The basic circuit configuration of a driving IC according to a third embodiment of the present invention is the same as that of the driving IC 100 of the Related Art 1 as shown in FIG. 8 except that gates of cells of the driving IC of the third embodiment are turned ON/OFF at different timings, while all cells (108a, 108b, and 108c) of the driving IC 100 of the Related Art 1 are turned ON/OFF at the same time.

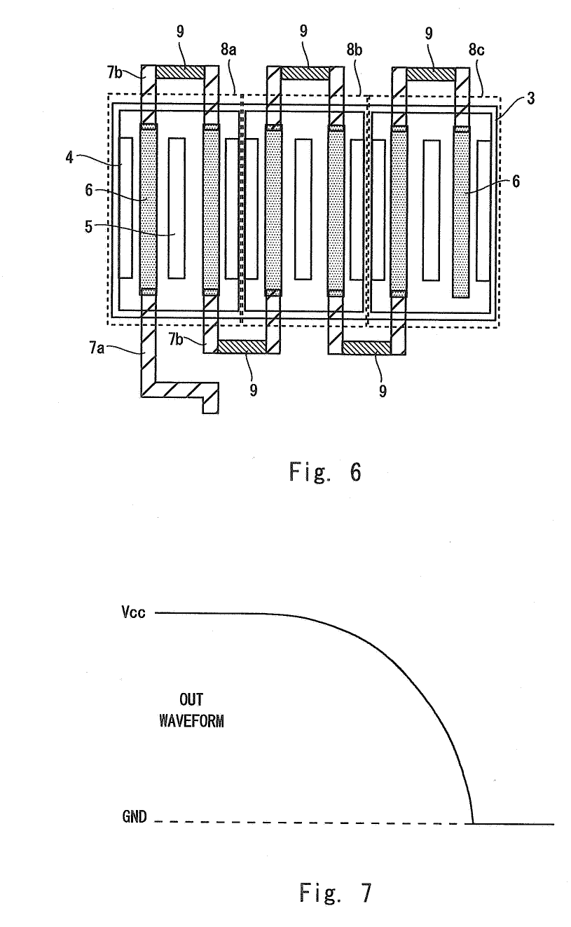

To be specific, in the driving IC 100 of the Related Art 1, the signal line 107 for inputting the third output control signal S3 is branched and connected to each gate electrode 106 in each cell. Meanwhile, in the third embodiment, a signal line 7a for transmitting the third output control signal S3 is connected to only one of the gate electrodes 6. As shown in FIG. 6, the output control signals S3 are transferred sequentially from the gate electrode 6 connected with the signal line 7a to adjacent gate electrodes 6 connected through the signal line 7b and high-resistance polysilicon 9. Here, a resistance value of the high-resistance polysilicon 9 is preferably 1 kΩ or higher.

FIG. 7 shows how an output waveform falls in a driving IC of the third embodiment. In this embodiment, the circuit is thus configured to shift ON/OFF timings of cells in stages. As a result, it is possible to avoid such a situation that the cells are turned ON/OFF at the same time. As shown in FIG. 7, stepless variable voltage control of a falling (or rising) waveform is realized, and a noise level can be reduced.

According to the third embodiment, owing to the above configuration, it is possible to provide a driving IC capable of reducing a noise level regardless of a current output power of a transistor. Further, similar to the first embodiment, the effect of suppressing the EMI is obtained. In addition, the dependence of the output load variations on the driving method of a display device can be reduced as compared with the conventional example.

Incidentally, in the third embodiment, the circuit is configured to shift ON/OFF timings of the gate electrodes 6 in one transistor. However, the signal line 7a for inputting the third output control signal S3 to the gate electrode can be appropriately shared among some of the plural gate electrodes 6 depending on required performance and characteristics of the display device. Further, some material other than the high-resistance polysilicon 9 can be used insofar as the material has variable characteristics required of the gate electrode and has a resistance value of 1 kΩ or higher. If the material having a resistance of 1 kΩ or higher is used, the gate ON/OFF timings can be effectively shifted. The resistance value is preferably less than 100 kΩ. This is because, if the resistance value is 100 kΩ or higher, ON resistance increases, so the output current power on the falling edge (or rising edge) reduces, and a malfunction may occur.

In the related arts, the gate electrode is made of a material having a resistance value of several to several tens of Ω (for example, polysilicon). The gate electrode 6 may be made of a material having a resistance value of 1 kΩ or higher (for example, polysilicon). In this case as well, it is preferred that a material having a resistance value of less than 100 kΩ be used for the same reason. The gate electrode 6 itself is made of a material having a resistance value of 1 kΩ or higher (for example, polysilicon), thereby making it possible to more effectively reduce a noise level and the dependence of the output load variations on the driving method of a display device.

Incidentally, the third embodiment may be combined with the first or second embodiment.

It is apparent that the present invention is not limited to the above embodiment that may be modified and changed without departing from the scope and spirit of the invention.

What is claimed is:

1. A driving IC incorporated in a display device, comprising:
a first field effect transistor among field effect transistors at an output stage, which is supplied with an output control signal not through the other field effect transistors;
a plurality of divided gate electrodes provided in the first field effect transistor; and
a delay unit shifting ON/OFF timings of at least a part of the plurality of gate electrodes.

2. The driving IC according to claim 1, wherein the delay unit includes:
an independent signal line independently supplying the output control signal to at least a part of the plurality of gate electrodes; and
a delay circuit provided to at least a part of the independent signal line.

3. The driving IC according to claim 1, wherein a plurality of the first field effect transistors are provided, and
ON/OFF timings of the gate electrodes of the first field effect transistors are shifted from one another by the delay unit.

4. The driving IC according to claim 2, wherein a plurality of the first field effect transistors are provided, and
ON/OFF timings of the gate electrodes of the first field effect transistors are shifted from one another by the delay unit.

5. The driving IC according to claim 1, wherein a gate electrode out of the plurality of gate electrodes, which is connected with the signal line from an input terminal for inputting the output control signal, and a gate electrode out of the plurality of gate electrodes, which is not connected with the signal line are connected with each other by a material having a resistance value of 1 kΩ or higher as the delay unit.

6. The driving IC according to claim 2, wherein a gate electrode out of the plurality of gate electrodes, which is connected with the signal line from an input terminal for inputting the output control signal, and a gate electrode out of the plurality of gate electrodes, which is not connected with the signal line are connected with each other by a material having a resistance value of 1 kΩ or higher as the delay unit.

7. The driving IC according to claim 1, wherein at least a part of the gate electrodes are made of materials having different resistance values as the delay unit.

8. The driving IC according to claim 2, wherein at least a part of the gate electrodes are made of a material having a resistance value of 1 kΩ or higher.

9. The driving IC according to claim 8, wherein the material having a resistance value of 1 kΩ or higher is polysilicon.

10. The driving IC according to claim 3, wherein at least a part of the gate electrodes are made of a material having a resistance value of 1 kΩ or higher.

11. The driving IC according to claim 10, wherein the material having a resistance value of 1 kΩ or higher is polysilicon.

12. The driving IC according to claim 5, wherein at least a part of the gate electrodes are made of a material having a resistance value of 1 kΩ or higher.

13. The driving IC according to claim 12, wherein the material having a resistance value of 1 kΩ or higher is polysilicon.

14. The driving IC according to claim 7, wherein at least a part of the gate electrodes are made of a material having a resistance value of 1 kΩ or higher.

15. The driving IC according to claim 14, wherein the material having a resistance value of 1 kΩ or higher is polysilicon.

16. A display device incorporating the driving IC according to claim 1.
